(19) United States
(12) Patent Application Publication
(10) Pub. No.: US 2006/0146276 A1
(43) Pub. Date: Jul. 6, 2006

(54) Magnet structure of eyeglasses assembly having auxiliary eyeglasses using hinge function

(75) Inventor: Hun-Yang Park, Daegu (KR)

Correspondence Address: MAYER, BROWN, ROWE & MAW LLP, 1909 K STREET, N.W., WASHINGTON, DC, 20006, US

(73) Assignee: Multi Vision, Inc.

(21) Appl. No.: 11/368,438

(22) Filed: Mar. 7, 2006

Related U.S. Application Data
(63) Continuation-in-part of application No. PCT/KR05/01104, filed on Apr. 18, 2005.

(30) Foreign Application Priority Data
Apr. 19, 2004 (KR) 20-2004-0010675

(51) Int. Cl. G02C 9/00

(52) U.S. Cl. 351/47

(57) ABSTRACT

An eyeglass assembly having primary eyeglasses and auxiliary eyeglasses which are openably and closably secured to the primary eyeglasses using magnets. The eyeglass assembly includes magnets for maintaining an opened state of the auxiliary eyeglasses when the auxiliary eyeglasses are openably secured to the primary eyeglasses in front of the primary eyeglasses, and magnets for maintaining a closed state of the auxiliary eyeglasses when the auxiliary eyeglasses are closably secured to the primary eyeglasses in front of the primary eyeglasses, thereby increasing a combining force between the primary eyeglasses and the auxiliary eyeglasses.

### CROSS REFERENCE TO RELATED APPLICATION

This application is a Continuation-in-Part application of International Application PCT/KR 2005/001104, with an international filing date of Apr. 18, 2005, which designates the United States and was published in English. This application, in its entirety, is incorporated herein by reference.

### BACKGROUND OF THE INVENTION

1. Field of the Invention

The present invention relates to a magnetic structure of an eyeglass assembly having auxiliary eyeglasses which are openably secured to primary eyeglasses in front of the primary eyeglasses and disassembled from the primary eyeglasses using a magnetic hinge function.

2. Description of Related Art

In connection with the above technology, various attempts have been made by the inventor of the present invention to create eyeglass assemblies. For example, Korean Utility Model Application No. 20-2002-0031831 discloses an eyeglass assembly having auxiliary eyeglasses using a hinge function of magnets and Korean Utility Model Application No. 20-2001-0036896 discloses an eyeglass assembly having auxiliary eyeglasses detachably and openably secured to primary eyeglasses in front of the primary eyeglasses using magnets.

In Korean Utility Model Application No. 20-2001-0036896, the eyeglass assembly includes: primary eyeglasses having a primary connection bar which horizontally connects the tops of lens rims of the primary eyeglasses and has a primary magnet inserted into the central portion thereof; and auxiliary eyeglasses having an auxiliary connection bar, which horizontally connects the tops of lens rims of the auxiliary eyeglasses and has a horizontal portion and a bent portion that is upwardly bent at right angles to the horizontal portion, and auxiliary magnets inserted into the horizontal portion and the bent portion thereof.

The magnets used according to the above technologies are operational, but it is necessary to promote additional convenience in use by increasing the combining force between the magnets according to an active user's demands and increasing a securing force between the primary eyeglasses and the auxiliary eyeglasses when the auxiliary eyeglasses are opened and/or closed.

### BRIEF SUMMARY OF THE INVENTION

Accordingly, the present invention has been made in view of the above problems occurring in the prior art and it is an object of the present invention to provide an eyeglass assembly having auxiliary eyeglasses which are openably and closably secured to the primary eyeglasses in front of the primary eyeglasses using a magnetic hinge function. In certain embodiments, the eyeglass assembly may include opening magnets combined with each other when the auxiliary eyeglasses are opened, and closing magnets combined with each other when the auxiliary eyeglasses closed, thereby continuously maintaining magnetic force of the magnets and maintaining the secured state between the primary eyeglasses and the auxiliary eyeglasses when a user wears the eyeglass assembly and moves actively.

### BRIEF DESCRIPTION OF THE DRAWINGS

Additional objects, features, and advantages of the present invention will become apparent from the following detailed description of embodiments of the invention in conjunction with the accompanying drawings where like reference numerals indicate like features, in which:

FIG. 1 is a perspective view of an eyeglass assembly;

FIG. 2 is a sectional view of an eyeglass assembly;

FIG. 3 is a perspective view showing an assembled state of an eyeglass assembly;

FIG. 4 is a perspective view of auxiliary eyeglasses according to an embodiment of the present invention;

FIGS. 5A, 5B and 5C are plan views of primary eyeglasses according to embodiments of the present invention;

FIG. 6 is an enlarged plan view of the primary eyeglasses and auxiliary eyeglasses according to an embodiment of the present invention;

FIG. 7 is a view showing an operation state of an eyeglass assembly according to an embodiment of the present invention;

FIG. 8 shows a front view and a plan view of the auxiliary eyeglasses according to an embodiment of the present invention;

FIG. 9 shows a front view and a plan view of the primary eyeglasses according to an embodiment of the present invention;

FIG. 10 is a perspective view of an eyeglass assembly according to an embodiment of the present invention; and

FIG. 11 is a view showing an eyeglass assembly according to an embodiment of the present invention in use.

In the Figures, the following reference numerals have the following meanings:

c: auxiliary closing magnet

c′: primary closing magnet

p: auxiliary opening magnet

p′: primary opening magnet

100: magnet hinge part

300: magnet part

### DETAILED DESCRIPTION OF EMBODIMENTS

According to the present invention, referring to a state where the auxiliary eyeglasses are opened in front, an eyeglass assembly having primary eyeglasses and auxiliary eyeglasses using a hinge function will be described.

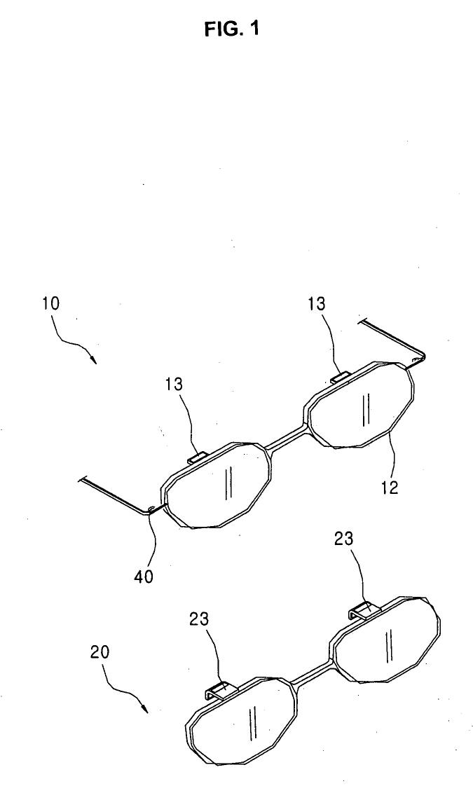

FIGS. 1-3 discloses an eyeglass assembly including primary eyeglasses and auxiliary eyeglasses using a hinge function of magnets. Referring to FIGS. 1-3, a magnet structure of an eyeglasses assembly including primary eyeglasses and auxiliary eyeglasses may include a primary magnet part 13 protruding inwardly from the upper portion of a lens rim 12 of the primary eyeglasses 10. The primary magnet part 13 has a primary magnet 13m inserted into the primary magnet part 13, and a magnet hinge part 23 bent from a portion of a lens rim 22 of the auxiliary eyeglasses 20 toward the primary eyeglasses 10 and corresponding to the upper surface 13a of the primary magnet part 13. A closing magnet 23m, inserted into a closing hinge part 23a which horizontally protrudes toward the inside of the eyeglasses, reacts with the upper surface 13a of the primary magnet part 13 by mutual magnetic force, the primary eyeglasses 10 and the auxiliary eyeglasses 20 are combined with each other and the auxiliary eyeglasses 20 can maintain a closed state in such a fashion that the auxiliary eyeglasses 20 are hung on the lens rim 12 of the primary eyeglasses 10.

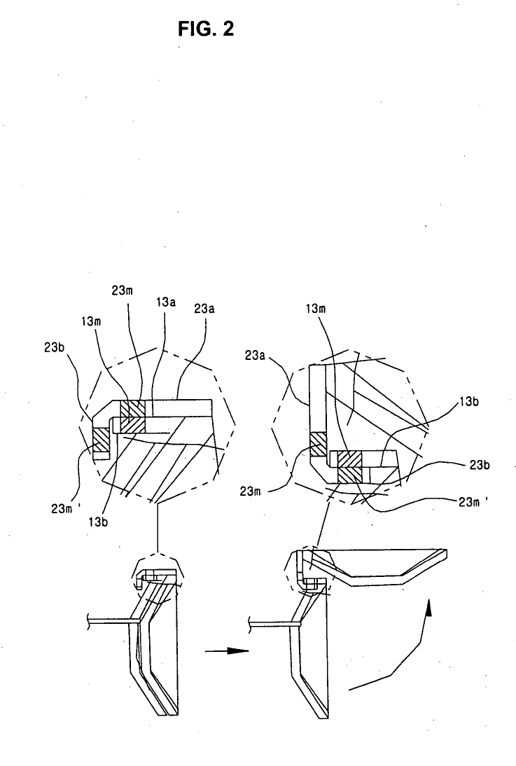

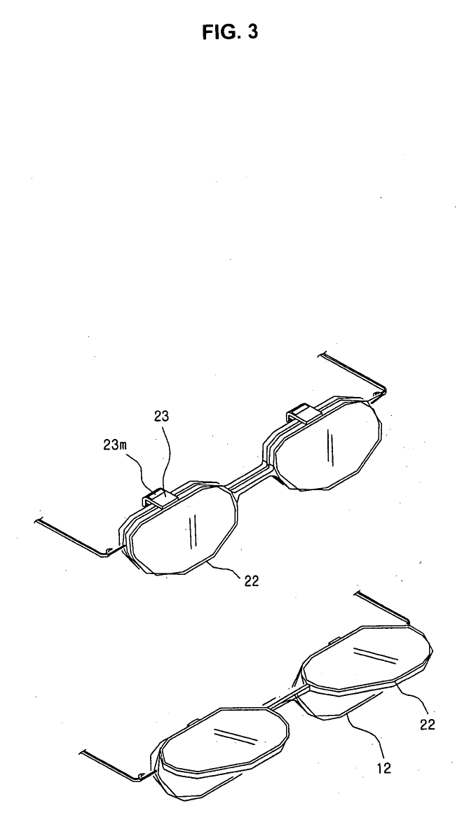

As shown in FIGS. 2 and 3, when a user forcibly lifts the auxiliary eyeglasses 20 upwardly in a state where the auxiliary eyeglasses 20 are closably secured to the primary eyeglasses 10 in front of the primary eyeglasses, the combining force between the upper surface 13a of the primary magnet part 13, into which the primary magnet 13m is inserted, and the closing hinge part 23a of the magnet hinge part 23 of the lens rim 22 of the auxiliary eyeglasses 20 is removed, and at the same time, an opening hinge part 23b bent in such a fashion as to surround the primary magnet part 13 comes into close contact with a lower surface 13b of the primary magnet part 13. Finally, the primary magnet 13m of the lower surface 13b of the primary magnet part 13 of the primary eyeglasses 10 and an opening magnet 23m′ mounted in the opening hinge part 23b of the magnet hinge part 23 of the auxiliary eyeglasses 20 are reacted and combined to each other by magnetic force so that the auxiliary eyeglasses 20 can be secured to the upper portion of the primary eyeglasses and maintain the opened state.

When the user forcibly lowers the auxiliary eyeglasses 20 in the front direction of the primary eyeglasses 10 in the opened state of the auxiliary eyeglasses 20, the combining force of the closing magnet 23m is removed by the user's force, and at the same time, the closing hinge part 23a of the auxiliary magnet hinge part 23 is bent and approaches toward the upper surface 13a of the primary magnet part 13 of the primary eyeglasses 10. Finally, the primary magnet 13m of the primary magnet part 13 of the primary eyeglasses 10 and the closing magnet 23m of the closing hinge part 23a of the auxiliary magnet hinge part 23 are combined with each other so that the auxiliary eyeglasses 20 can be secured to the primary eyeglasses 10 in front and maintained the closed state.

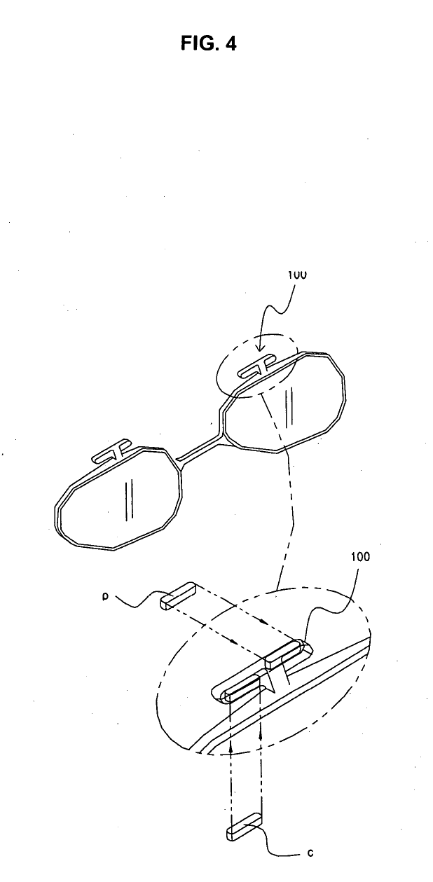

Referring to FIGS. 4-7, the structure and operation of an eyeglass assembly in accordance with an embodiment of the present invention will be described in detail.

As described above, an eyeglass assembly has primary eyeglasses and auxiliary eyeglasses openable and closable using the hinge function of the magnets. To combine the magnets of the primary eyeglasses and the magnets of the auxiliary eyeglasses, certain embodiments of the present invention includes an auxiliary closing magnet (c) and a primary closing magnet (c′) which are operated upon the closing of the auxiliary eyeglasses and an auxiliary opening magnet (p) and a primary opening magnet (p′) which are operated upon the opening of the auxiliary eyeglasses. The auxiliary closing magnet (c) and the auxiliary opening magnet (p) are mounted on a hinge part 100 of the auxiliary eyeglass, and the primary closing magnet (c′) and the primary opening magnet (p′) are mounted on a magnet holding part 300 of the primary eyeglasses. Therefore, in the embodiments shown in FIGS. 4-7, the eyeglass assembly includes magnets that function differently depending on the opening and closing of the auxiliary eyeglasses so as to increase the securing force and extend the lifespan of the magnets.

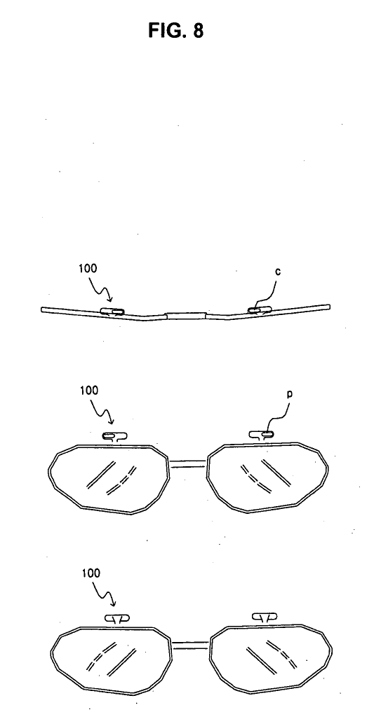

As shown in FIGS. 4 and 8, the hinge part 100 of the lens rim of the auxiliary eyeglasses is in the form of a rectangular parallelepiped bar, the auxiliary closing magnet (c) is mounted on the closing hinge part located at the lower surface of the hinge part 100, and the auxiliary opening magnet (p) is mounted on the opening hinge part toward the primary eyeglasses.

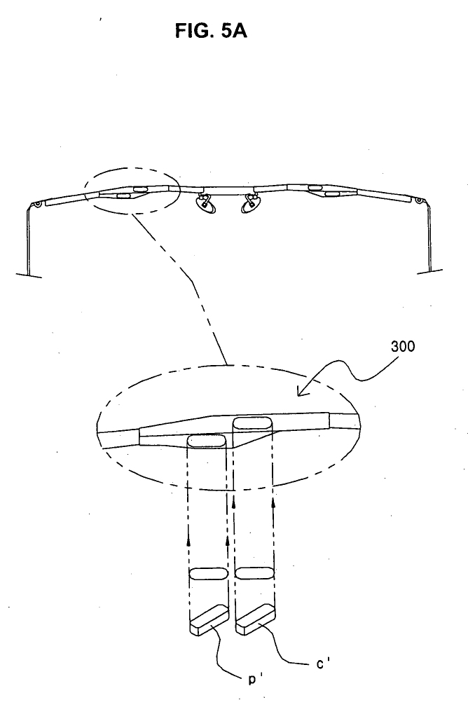

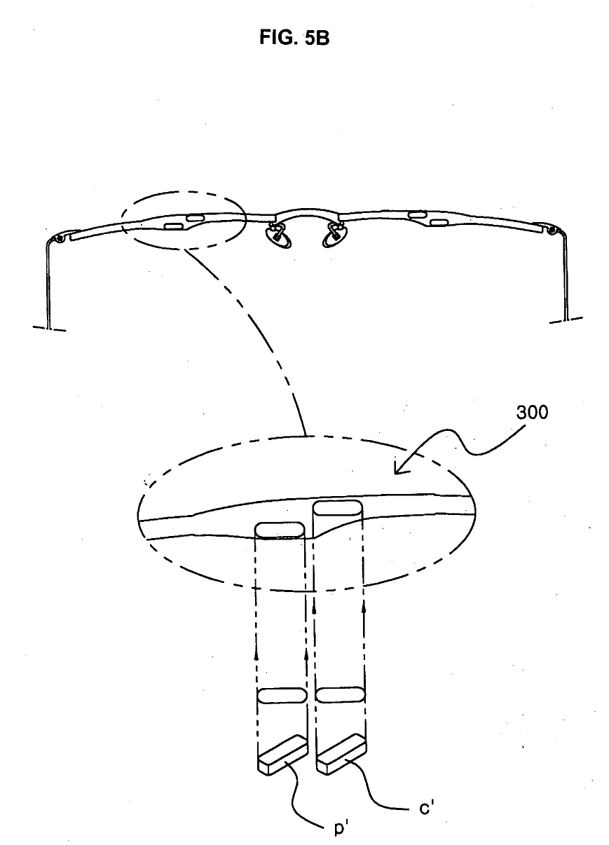

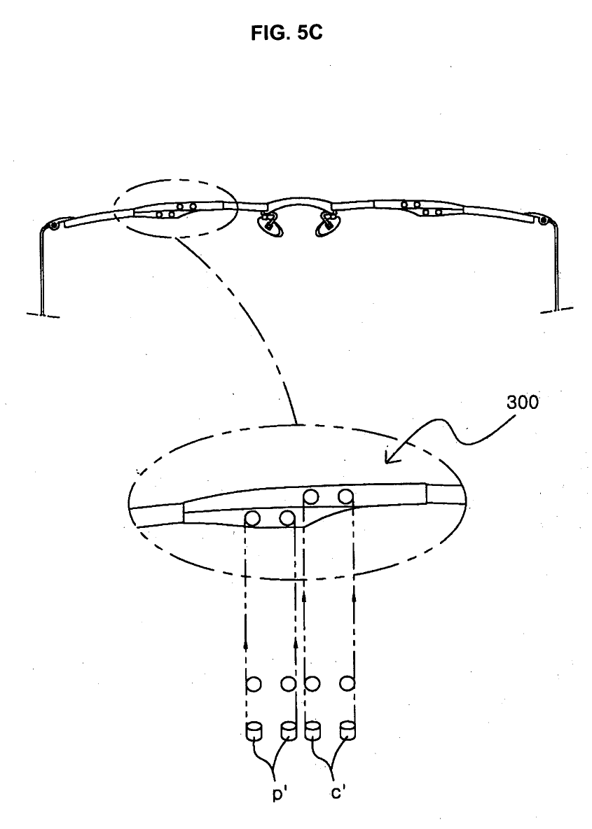

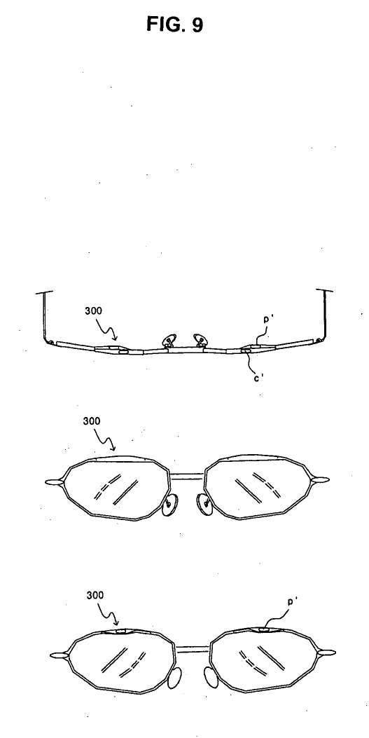

As shown in FIGS. 5A, 5B, 5C and 9, unlike the conventional eyeglass assembly which has only one primary magnet combined with the auxiliary magnet without regard to opening and closing of the auxiliary eyeglasses, the magnet part 300 of the primary eyeglasses combined with the hinge part 100 of the lens rim of the auxiliary eyeglasses, according to certain embodiments of the present invention, may include a primary closing magnet (c′) mounted on the corresponding surface thereof on which the auxiliary closing magnet (c) is put and secured, and a primary opening magnet (p′) mounted on a bent portion downwardly bent at a certain angle toward the inside of the primary eyeglasses. Additionally, as shown in FIGS. 5A and 5B, the magnet part 300 may be separately attached to primary eyeglasses (see, FIG. 5A) of, alternatively, the magnet part 300 may be integral to the primary eyeglasses. In this manner, the magnet part, in certain embodiments, may be removable from the primary eyeglasses. FIG. 5C shows yet another embodiment of the present invention. As shown in FIG. 5c, the primary closing magnets (c′) and the primary opening magnet (p′) each may consists of a plurality of magnets. The embodiment illustrated in FIG. 5C shows two magnets of the primary closing magnets (c′) and two magnets of the primary opening magnets (p′).

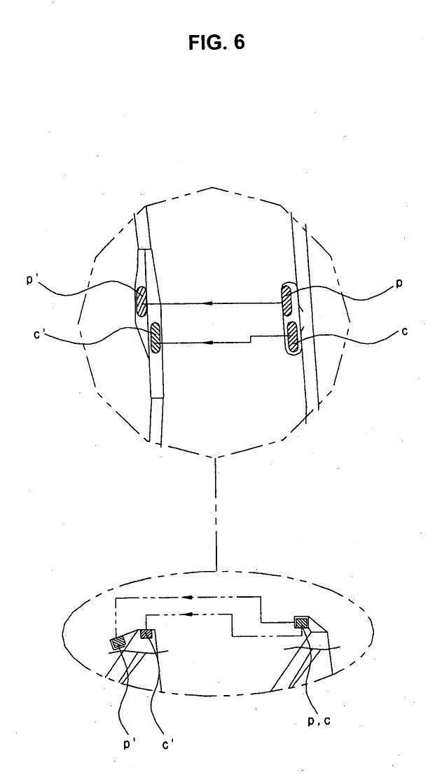

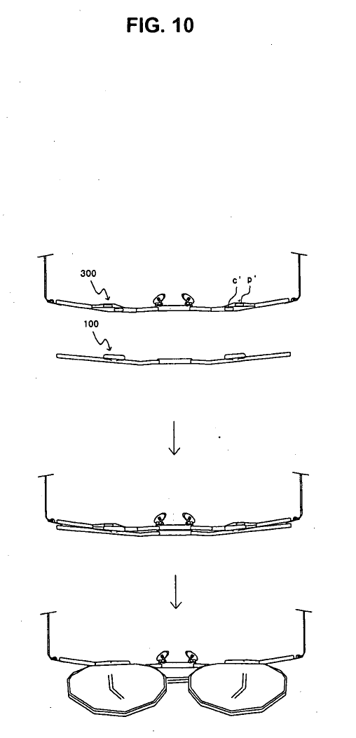

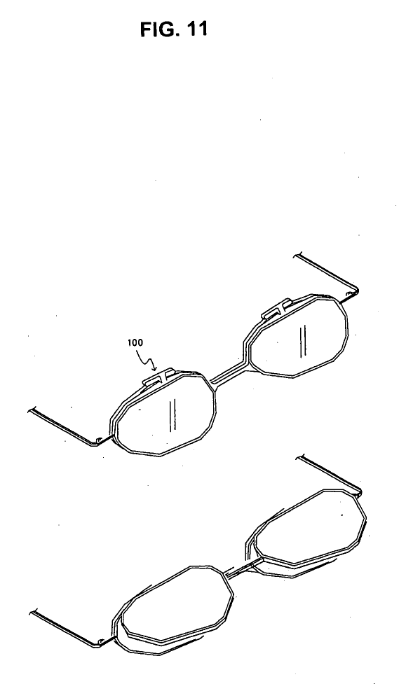

As shown in FIGS. 6, 10 and 11, the auxiliary closing magnet (c) is mounted on the lower surface of the hinge part 100 and is put and secured on the primary closing magnet (c′), at which time, the auxiliary opening magnet (p) is directed toward the inside of the primary eyeglasses.

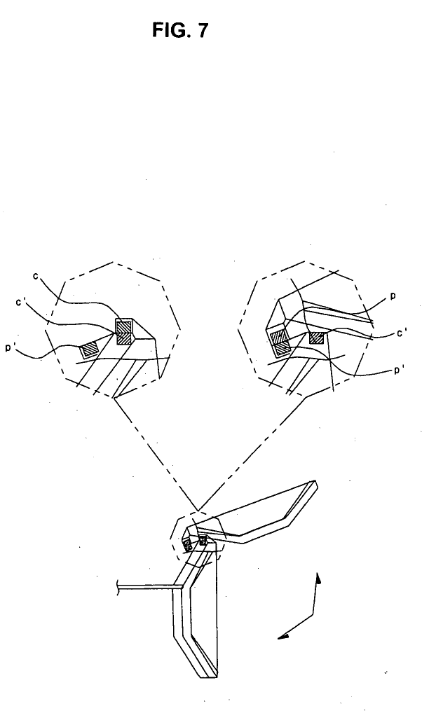

As shown in FIGS. 7, 10 and 11, when the user lifts the auxiliary eyeglasses upwardly, the combining force between the two magnets (c and c′) combined with each other during the closing of the auxiliary eyeglasses is released, and at the same time, the hinge part 100 of the auxiliary eyeglasses is generally bent and pushed inwardly, so that the auxiliary opening magnet (p) is combined with the primary opening magnet (p′) mounted on the bent portion bent toward the inside of the magnet part 300 of the primary eyeglasses, and thus the auxiliary eyeglasses can be opened.

As described above, according to the structure of the eyeglass assembly having the auxiliary eyeglasses using the hinge function, the present invention includes a pair of opening magnets and a pair of closing magnets, each of which continuously has interaction only with the corresponding magnet having the same function, so that the present invention can maintain the magnetic force for an increased time and increase their combining force. As a result, the present invention can provide convenience in use to active eyeglasses wearers.

Many alterations and modifications of the present invention will be comprehended by a person skilled in the art after having read the foregoing description. It is to be understood that the particular embodiments shown and described by way of illustration are in no way intended to be considered limiting. Therefore, references to details of particular embodiments are not intended to limit the scope of the claims, which in themselves recite only those features regarded as essential to the invention.

The embodiments described herein are intended to be illustrative of this invention. As will be recognized by those of ordinary skill in the art, various modifications and changes can be made to these embodiments and such variations and modifications would remain within the spirit and scope of the invention defined in the appended claims and their equivalents. Additional advantages and modifications will readily occur to those of ordinary skill in the art. Therefore, the invention in its broader aspects is not limited to the specific details and representative embodiments shown and described herein.

What is claimed is:

1. A magnetic structure of an eyeglass assembly having primary eyeglasses and auxiliary eyeglasses which are selectively opened and closed using a hinge function of magnets, the magnetic structure comprising:
a hinge part protruding from a lens rim of the auxiliary eyeglasses in the form of a rectangular parallelepiped bar, the hinge part having an auxiliary closing magnet mounted on a closing hinge part located at the lower surface of the hinge part and an auxiliary opening magnet mounted on an opening hinge part directed toward the primary eyeglasses; and
a magnet part formed on a lens rim of the primary eyeglasses, the magnet part having a primary closing magnet mounted on the corresponding surface thereof on which the auxiliary closing magnet is put and secured, and a primary opening magnet mounted on a bent portion downwardly bent at a certain angles toward the inside of the primary eyeglasses.

2. The magnetic structure of claim 1, wherein the magnet part is removable from the lens rim of the primary eyeglasses.

3. The magnetic structure of claim 2, wherein each of the primary closing magnet and the primary opening magnet consists of more than one magnet.

4. An eyeglass assembly having primary eyeglasses and auxiliary eyeglasses which are selectively opened and closed using a hinge function of magnets, the eyeglass assembly comprising:
primary eyeglasses;
auxiliary eyeglasses;
a hinge part protruding from a lens rim of the auxiliary eyeglasses in the form of a rectangular parallelepiped bar, the hinge part having an auxiliary closing magnet mounted on a closing hinge part located at the lower surface of the hinge part and an auxiliary opening magnet mounted on an opening hinge part directed toward the primary eyeglasses; and
a magnet part formed on a lens rim of the primary eyeglasses, the magnet part having a primary closing magnet mounted on the corresponding surface thereof on which the auxiliary closing magnet is put and secured, and a primary opening magnet mounted on a bent portion downwardly bent at a certain angles toward the inside of the primary eyeglasses.

5. The eyeglass assembly of claim 4, wherein the magnet part is removable from the lens rim of the primary eyeglasses.

6. The magnetic structure of claim 5, wherein each of the primary closing magnet and the primary opening magnet consists of more than one magnet.

7. A system comprising:
primary eyeglasses and auxiliary eyeglasses which are selectively opened and closed using a hinge function of magnets;
a hinge part protruding from a lens rim of the auxiliary eyeglasses in the form of a rectangular parallelepiped bar, the hinge part having an auxiliary closing magnet mounted on a closing hinge part located at the lower surface of the hinge part and an auxiliary opening magnet mounted on an opening hinge part directed toward the primary eyeglasses; and
a magnet part formed on a lens rim of the primary eyeglasses, the magnet part having a primary closing magnet mounted on the corresponding surface thereof on which the auxiliary closing magnet is put and secured, and a primary opening magnet mounted on a bent portion downwardly bent at a certain angles toward the inside of the primary eyeglasses.

8. The system of claim 7 wherein the magnet part is removable from the lens rim of the primary eyeglasses.

9. The magnetic structure of claim 8, wherein each of the primary closing magnet and the primary opening magnet consists of more than one magnet.
